(19) United States
(12) Patent Application Publication
(10) Pub. No.: US 2023/0339307 A1
(43) Pub. Date: Oct. 26, 2023

(54) BATTERY STRUCTURE AND BATTERY HOUSING

(71) Applicant: Cummins Inc., Columbus, IN (US)

(72) Inventors: Daniel Riegels, Ashland, OR (US); Kedar Karajagi, Medford, OR (US); Christofer Durkin, Columbus, IN (US); Rick Vaughan Lewis, JR., Medford, OR (US)

(21) Appl. No.: 18/136,728

(22) Filed: Apr. 19, 2023

Related U.S. Application Data
(60) Provisional application No. 63/333,720, filed on Apr. 22, 2022.

(51) Int. Cl. B60K 1/04; H01M 50/244; H01M 50/218; H01M 50/26; H01M 10/653

(52) U.S. Cl. CPC B60K 1/04; H01M 50/244; H01M 50/218; H01M 50/26; H01M 10/653; B60K 2001/0455; H01M 2220/20

(57) ABSTRACT

Disclosed are designs for batter assemblies. In some embodiments, a battery assembly includes: a battery housing is made from a first material; a battery structure disposed in the battery housing and is made from a second material different from the first material; and a battery comprising a plurality of battery cells disposed on the battery structure; and wherein the battery housing is sealed.

### CROSS REFERENCE TO RELATED APPLICATIONS

This application claims priority to U.S. Provisional Application No. 63/333,720 filed Apr. 22, 2022, which is incorporated by reference herein for all purposes.

### BACKGROUND OF THE DISCLOSURE

Certain battery packs such as for battery-electric or hybrid-electric vehicles are manufactured by placing multiple battery sub-packs, each with a plurality of modules connected to one another and mounted on a frame within an enclosure, where each battery module may include a plurality of battery cells. Weight of the battery pack is a key concern for on vehicle applications. Conventional battery packs have relatively low gravimetric energy density (i.e., energy per unit weight such as kWh/kg), in part due to the structural elements inside all of the sub-pack modules, which add weight. Additionally, conventional battery packs have relatively low volumetric efficiency, which is a measure of energy provided per unit volume. Accordingly, there is a need for improvements in battery pack design to increase volumetric and gravimetric efficiency.

### SUMMARY

At least some embodiments of the present disclosure are directed to a battery assembly, comprising: a battery housing is made from a first material; a battery structure disposed in the battery housing and is made from a second material different from the first material; and a battery comprising a plurality of battery cells disposed on the battery structure; and wherein the battery housing is sealed.

At least certain embodiments of the present disclosure are directed to a battery assembly, comprising: a battery housing is made from a first material; a battery structure disposed in the battery housing and is made from a second material different from the first material; and a battery comprising a plurality of battery cells disposed on the battery structure; and wherein the battery housing is sealed; wherein the battery includes a plurality of battery cells, wherein the plurality of battery cells are supported by the battery structure.

At least some embodiments of the present disclosure are directed to a battery assembly, comprising: a battery housing having a general top surface and a first side structure protruded from the general top surface; a battery structure disposed in the battery housing; a battery disposed in the battery housing and supported by the battery structure; and a mounting device mechanically coupled to the battery structure.

### BRIEF DESCRIPTION OF THE DRAWINGS

The above-mentioned and other features of this disclosure and the manner of obtaining them will become more apparent and the disclosure itself will be better understood by reference to the following description of embodiments of the present disclosure taken in conjunction with the accompanying drawings, wherein:

FIG. 1A is a perspective view of a schematic design of an example battery assembly; FIG. 1B is a first side view of the schematic design of the example battery assembly illustrated in FIG. 1A; and FIG. 1C is a second side view of the schematic design of the example battery assembly illustrated in FIG. 1A;

FIG. 2 is an exploded view of a schematic design of an example battery assembly;

FIG. 3 is an exploded view of a schematic design of an example battery assembly;

FIG. 4A is an exploded view of a schematic design of an example battery assembly; FIG. 4B is a perspective view of the example battery assembly illustrated in FIG. 4A when the battery assembly is assembled; and FIG. 4C is a different perspective view of the example battery assembly illustrated in FIG. 4A;

FIG. 5 is a perspective view of a schematic design of an example battery assembly set; and

FIG. 6A is an exploded view of a schematic design of an example battery assembly; FIG. 6B is a perspective view of the example battery assembly illustrated in FIG. 6A when the battery assembly 600 is assembled; and FIG. 6C is an enlarged view of a portion of the example battery assembly illustrated in FIG. 6A.

### DETAILED DESCRIPTION

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein. The use of numerical ranges by endpoints includes all numbers within that range (e.g., 1 to 5 includes 1, 1.5, 2, 2.75, 3, 3.80, 4, and 5) and any range within that range.

As used in this specification and the appended claims, the singular forms “a,” “an,” and “the” encompass embodiments having plural referents, unless the content clearly dictates otherwise. As used in this specification and the appended claims, the term “or” is generally employed in its sense including “and/or” unless the content clearly dictates otherwise.

As used herein, when an element, component, device or layer is described as being “on” “connected to,” “coupled to” or “in contact with” another element, component, device or layer, it can be directly on, directly connected to, directly coupled with, in direct contact with, or intervening elements, components, devices or layers may be on, connected, coupled or in contact with the particular element, component or layer, for example. When an element, component, device or layer for example is referred to as being “directly on,” “directly connected to,” “directly coupled to,” or “directly in contact with” another element, component, device or layer, there are no intervening elements, components, devices or layers for example.

Although illustrative methods may be represented by one or more drawings (e.g., flow diagrams, communication flows, etc.), the drawings should not be interpreted as implying any requirement of, or particular order among or between, various steps disclosed herein. However, certain some embodiments may require certain steps and/or certain orders between certain steps, as may be explicitly described herein and/or as may be understood from the nature of the steps themselves (e.g., the performance of some steps may depend on the outcome of a previous step). Additionally, a “set,” “subset,” “series” or “group” of items (e.g., inputs, algorithms, data values, etc.) may include one or more items, and, similarly, a subset or subgroup of items may include one or more items. A “plurality” means more than one.

As used herein, the term “based on” is not meant to be restrictive, but rather indicates that a determination, identification, prediction, calculation, and/or the like, is performed by using, at least, the term following “based on” as an input. For example, predicting an outcome based on a particular piece of information may additionally, or alternatively, base the same determination on another piece of information.

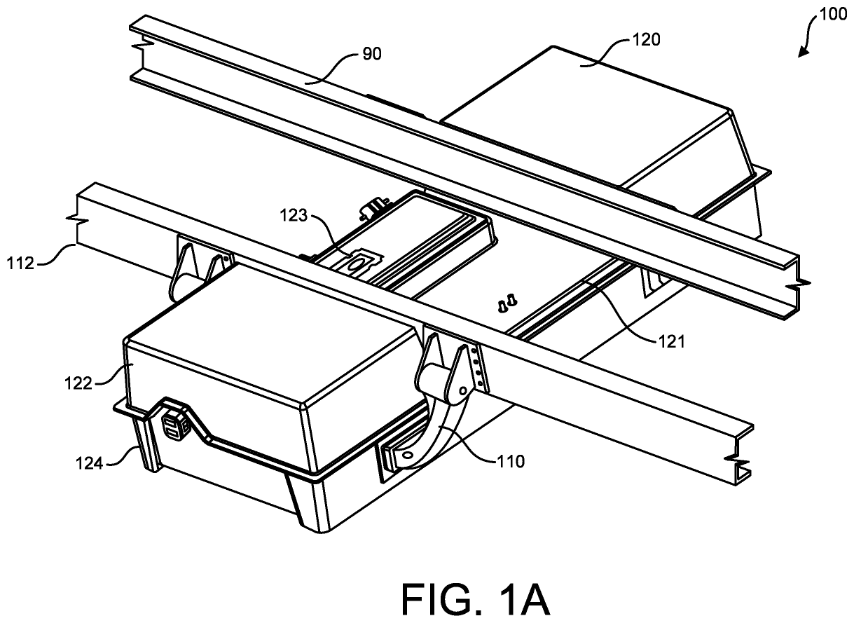

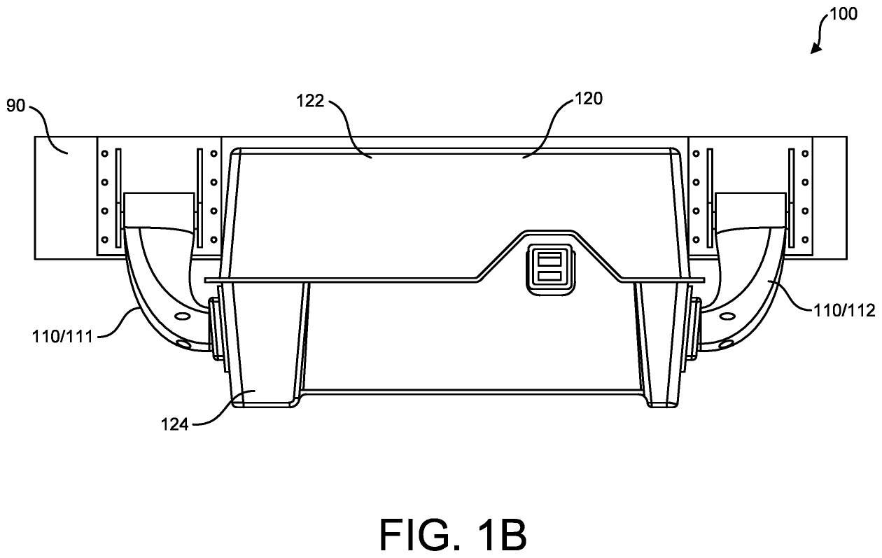

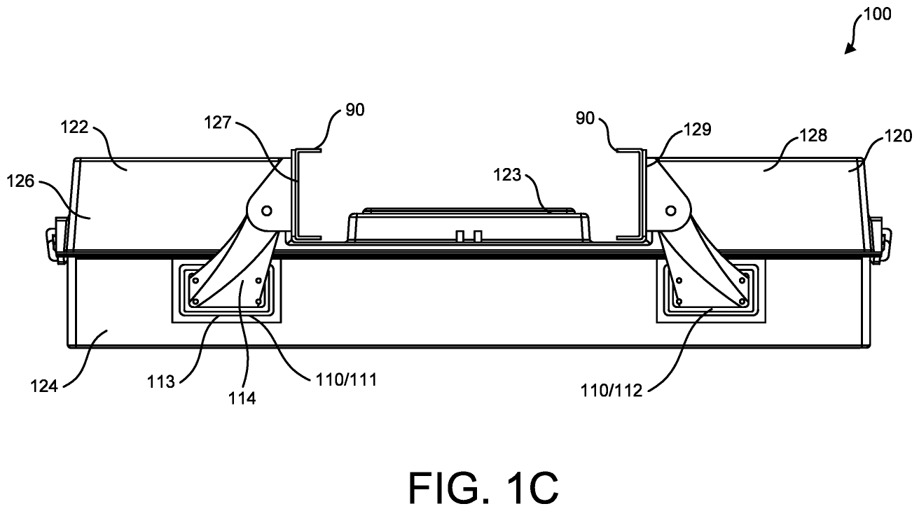

FIG. 1A is a perspective view of a schematic design of an example battery assembly 100; FIG. 1B is a first side view of the schematic design of the example battery assembly 100 illustrated in FIG. 1A; and FIG. 1C is a second side view of the schematic design of the example battery assembly 100 illustrated in FIG. 1A. FIGS. 1A-1C illustrate merely an example. One of ordinary skill in the art would recognize many variations, alternatives, and modifications. According to certain embodiments, the battery assembly 100 includes a battery housing 120, a battery structure (not shown), and a mounting device 110. Although the above has been shown using a selected group of components for the battery assembly 100, there can be many alternatives, modifications, and variations. For example, some of the components may be expanded and/or combined. Other components may be inserted to those noted above. Depending upon the embodiment, the arrangement of components may be interchanged with others replaced.

According to certain embodiments, the battery housing 120 includes a top housing 122 and a bottom housing 124. In some embodiments, the battery housing 120 includes a general surface 121 and a first side structure 126 protruded from the general surface 121 and a second side structure 128 protruded from the general surface 121. In certain embodiments, the battery housing 120 is in a U-shape in a side view, for example, as illustrated in FIG. 1C. In some embodiments, the first side structure 126 has a first side surface 127 and the second side structure 128 has a second side surface 129 facing the first side surface 127. In certain embodiments, the battery housing 120 is a sealed housing. In some embodiments, the battery housing 120 includes a protrusion structure 123 between the first side structure 126 and the second side structure 128. In certain embodiments, the protrusion structure 123 is configured to have one or more wires and ports disposed thereon.

According to some embodiments, the mounting device 110 includes one or more mounting components. In some embodiments, the mounting device 110 includes a first mounting component 111 and a second mounting component 112. In certain embodiments, the first mounting component 111 is disposed proximate to the first side structure 126 and the second mounting component 112 is disposed proximate to the first side structure 126. In some embodiments, the mounting device 110 includes one or more mounting components (not shown) disposed proximate to the second side structure 128. In certain embodiments, the mounting component 111 includes a sealing bracket 113 and a mounting extension 114. In some embodiments, the mounting device 110 is configured to mechanically couple to a rail 90 (e.g., chassis rail) in a vehicle. In certain embodiments, the mounting component 111 and/or the mounting component 112 is configured to mechanically couple to a rail 90 (e.g., a chassis rail, a vehicle chassis rail) in a vehicle. In some embodiments, the mounting device 110 allows side mounting of the battery assembly 100 (e.g., a U-shaped truck battery). In certain embodiments, side mounted batteries enable simple vehicle attachment bracketry design and simple installation/removal access within the vehicle. In some embodiments, the mounting device 110 can facilitate attachment/integration into vehicle. For example, the mounting device 110 allows ease of service. In certain embodiments, the mounting device 110 (e.g., side mount attachment), for example, attached to the battery housing 120, can increase usable volume in vehicle to package batteries within, and facilitate (e.g., ease) battery-vehicle integration.

According to certain embodiments, the mounting device 110 is mechanically coupled to the battery structure disposed in the battery housing 120. In some embodiments, the battery housing 120 is designed not to support the battery. In certain embodiments, the battery structure is configured to support battery including, for example, a plurality of battery modules, a plurality of battery cells. In some embodiments, the mounting device 110 is mechanically coupled to the battery structure to reduce the complexity of sealing. In some embodiments, the battery structure is made from a first material (e.g., a metal, aluminum) and the battery housing 120 is made from a second material (e.g., fiber glass, thermal-insulated material), where the first material is different from the second material. In certain embodiments, the first material is a metal material. In some embodiments, the second material is a non-metallic material. In certain embodiments, the second material has a lower cost than the first material. In some embodiments, the second material is a thermal insulated material allowing the enclosed battery (include battery modules and battery cells) to control the battery temperature independent from the environment. In certain embodiments, the first material has a thermal conductivity higher than the thermal conductivity of the second material. In certain embodiments, the battery housing 120 can provide a sealed enclosure for the battery structure and battery (e.g., battery cells, battery packs) inside. In some embodiments, the second material is a conformable material. In certain embodiments, the first material is a non-conformable material (e.g., a rigid material).

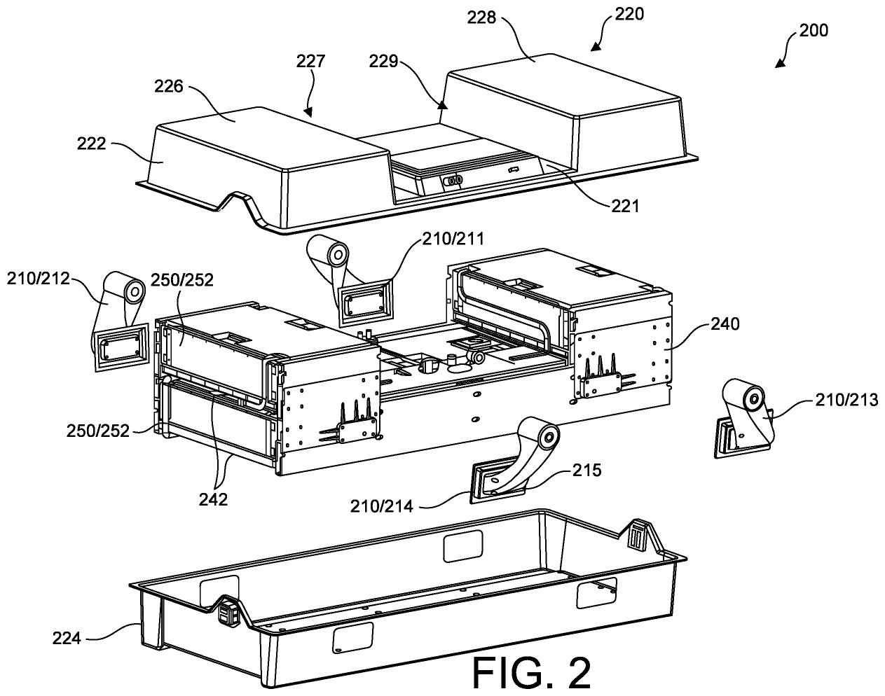

FIG. 2 is an exploded view of a schematic design of an example battery assembly 200. FIG. 2 is merely an example. One of ordinary skill in the art would recognize many variations, alternatives, and modifications. According to certain embodiments, the battery assembly 200 includes a battery housing 220, one or more mounting devices 210, a battery structure 240, and a battery 250 (e.g., a battery including battery modules, a battery including battery cells). Although the above has been shown using a selected group of components for the battery assembly 200, there can be many alternatives, modifications, and variations. For example, some of the components may be expanded and/or combined. Other components may be inserted to those noted above. Depending upon the embodiment, the arrangement of components may be interchanged with others replaced.

According to certain embodiments, the battery housing 220 includes a top housing 222 and a bottom housing 224. In some embodiments, the battery housing 220 includes a general top surface 221 and a first side structure 226 protruded from the general top surface 221 and a second side structure 228 protruded from the general top surface 221. In certain embodiments, the battery housing 220 is in a U-shape in a side view. In some embodiments, the first side structure 226 has a first side surface 227 and the second side structure 228 has a second side surface 229 facing the first side surface 227. In certain embodiments, the battery housing 220 is a sealed housing. In some embodiments, the separate battery housing 220 can improve sealing reliability.

According to some embodiments, the battery housing 220 contains the battery structure 240 and the battery 250. In certain embodiments, the battery structure 240 includes one or more supporting components 242. In some embodiments, the battery structure 240 includes a plurality of supporting components 242. In certain embodiments, the battery 250 includes one or more battery cells 252, also referred to as battery modules 252. In some embodiments, a battery cell 252 is a battery pack. In certain embodiments, a battery 250 includes one or more battery modules, and a battery module includes one or more battery cells. In some embodiments, the battery cell (e.g., battery module) 252 includes a cooling component, for example, at a bottom side. In certain embodiments, a battery cell 252 is a battery pack without battery module(s). In some embodiments, a battery 250 includes electrical conductors and/or sensors.

According to certain embodiments, the battery assembly 200 has a separate battery structure 240 and the battery housing 220 (e.g., a non-structural sealed housing). In some embodiments, the separation of the battery structure from the battery housing enables a few benefits. In some examples, the battery assembly can use cost-effective housing parts. For example, the housing part have no structural requirements.

According to some embodiments, the mounting device 210 includes one or more mounting components 211, 212, 213, 214. In some embodiments, the mounting device 210 includes a first mounting component 211 and a second mounting component 212. In certain embodiments, the first mounting component 211 is disposed proximate to the first side structure 226 and the second mounting component 212 is disposed proximate to the first side structure 226. In some embodiments, the mounting device 210 includes one or more mounting components (213, 214 disposed proximate to the second side structure 228. In certain embodiments, the mounting component 211 includes a sealing bracket and a mounting extension. In some embodiments, the mounting device 210 is configured to mechanically couple to a rail (e.g., chassis rail) in a vehicle. In certain embodiments, one or more mounting components are configured to mechanically couple to a rail (e.g., chassis rail) in a vehicle. In some embodiments, the mounting device 210 allows side mounting of the battery assembly 200 (e.g., a U-shaped truck battery). In certain embodiments, side mounted batteries enable simple vehicle attachment bracketry design and simple installation/removal access within the vehicle. In some embodiments, the mounting device 210 can facilitate attachment/integration into vehicle. For example, the mounting device 210 allows ease of service. In certain embodiments, the mounting device 210 (e.g., side mount attachment), for example, attached to the battery housing 220, can increase usable volume in vehicle to package batteries within, and facilitate (e.g., ease) battery-vehicle integration.

According to certain embodiments, the mounting device 210 is mechanically coupled to the battery structure 240 disposed in the battery housing 220. In some embodiments, the mounting device 210 is mechanically coupled to the battery structure 240 to reduce the complexity of sealing. In some examples, the mounting device 210 is mechanically coupled to the battery structure 240 to carry structural loads. In certain embodiments, the battery structure 240 is configured to support the battery 250 including, for example, a plurality of battery modules, a plurality of battery cells. In some embodiments, the battery structure 240 is made from a first material (e.g., a metal, aluminum) and the battery housing 220 is made from a second material (e.g., fiber glass, thermal-insulated material, composite), where the first material is different from the second material. In certain embodiments, the first material is a metal material. In some embodiments, the second material is a non-metallic material. In certain embodiments, the second material has a lower cost than the first material. In some embodiments, the second material is a thermal insulated material allowing the enclosed battery (include battery modules and battery cells) to control the battery temperature independent from the environment. In certain embodiments, the first material has a thermal conductivity higher than the thermal conductivity of the second material. In certain embodiments, the battery housing can provide a sealed enclosure for the battery structure and battery (e.g., battery cells, battery packs) inside. In some embodiments, the second material is a conformable material. In certain embodiments, the first material is a non-conformable material (e.g., a rigid material).

According to some embodiments, the battery housing 220 is a non-structural housing. In certain embodiments, the non-structural battery housing 220 is made from conformable material (e.g., flexible material). In In some examples, the battery housing 220 is made from flame retardant materials, for example, providing fire barriers to both internal battery fires (e.g., protects vehicle/people) and/or from external fuel fires (e.g., protecting battery during vehicle-vehicle crash). In certain embodiments, non-structural housing can be made from electrically insulating materials, for example, providing robust high-voltage protection from battery to vehicle/occupants. In some embodiments, non-structural housing can be easily replaced if damaged (e.g., due to road debris, etc.) without replacement of the battery. In certain embodiments, the battery housing is replaceable without replacing battery. In some embodiments, the mounting device 210 includes a portion disposed within the battery housing 220 when the battery assembly 200 is assembled. In certain examples, the mounting device 210 includes a plate 215 disposed within the battery housing 220 when the battery assembly 200 is assemble. In some embodiments, the mounting device 210 includes a portion disposed within the battery housing 220 when the battery assembly 200 is assemble.

In some examples, for the example battery assembly 200, manufacturability of battery 250 and/or the battery structure 240 is simpler, as the battery structure 240 is not required to protect all faces of the battery 250, and the battery 250 can be sealed in the battery housing 220. In certain examples, the battery housing 220 (e.g., a non-structural housing, a non-structural sealed housing) wraps the battery to accomplish this. In some examples, the non-structural housing decouples the battery structure from external sealed housing. In certain examples, decoupling these parts simplifies design/assembly, lowers costs, improves reliability, eases serviceability, and improves product safety.

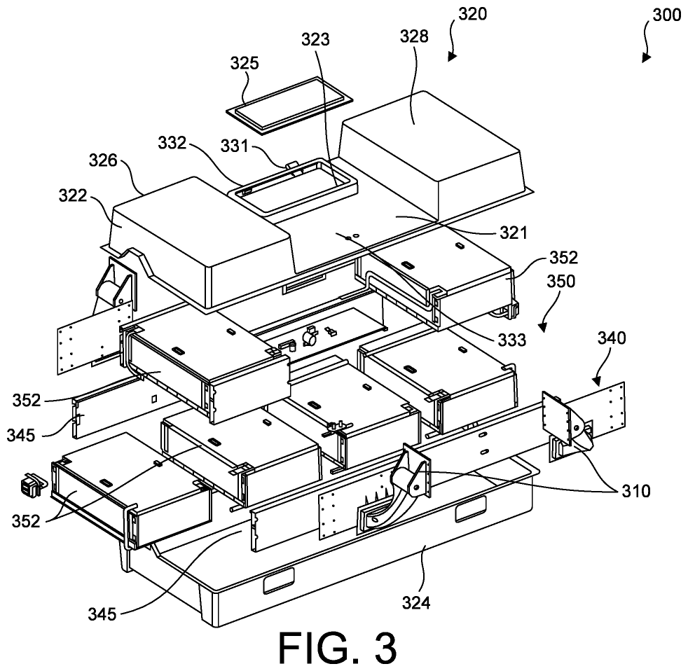

FIG. 3 is an exploded view of a schematic design of an example battery assembly 300. FIG. 3 is merely an example. One of ordinary skill in the art would recognize many variations, alternatives, and modifications. According to certain embodiments, the battery assembly 300 includes a battery housing 320, one or more mounting devices 310, a battery structure 340, and a battery 350. Although the above has been shown using a selected group of components for the battery assembly 300, there can be many alternatives, modifications, and variations. For example, some of the components may be expanded and/or combined. Other components may be inserted to those noted above. Depending upon the embodiment, the arrangement of components may be interchanged with others replaced.

According to certain embodiments, the battery housing 320 includes a top housing 322 and a bottom housing 324. In some embodiments, the battery housing 320 includes a general top surface 321 and a first side structure 326 protruded from the general top surface 321 and a second side structure 328 protruded from the general top surface 321. In certain embodiments, the battery housing 320 is in a U-shape in a side view. In some embodiments, the battery housing 320 is a sealed housing. In certain embodiments, the separate battery housing 320 can improve sealing reliability. In some embodiments, the battery housing 320 includes a protrusion structure 323 between the first side structure 326 and the second side structure 328. In certain embodiments, the protrusion structure 323 is configured to have one or more wires and ports 331, 332 (e.g., power port, communication port) disposed thereon. In some embodiments, the battery housing 320 includes one or more cooling ports 333.

According to some embodiments, the battery housing 320 contains the battery structure 340 and the battery 350. In certain embodiments, the battery structure 340 includes one or more supporting structures 345. In some embodiments, the battery structure 340 includes a plurality of supporting structures 345. In certain embodiments, the battery 350 includes one or more battery modules 352, also referred to as battery cells. In some embodiments, a battery cell 352 is a battery pack. In certain embodiments, a battery cell 352 is a battery module that further includes a plurality of battery cells. In some embodiments, the battery module (e.g., a battery cell) 352 includes a cooling component, for example, at a bottom side. In certain embodiments, a battery cell 352 is a battery pack without battery module(s). In some embodiments, a battery 350 includes electrical conductors and/or sensors.

According to certain embodiments, the battery assembly 300 has a separate battery structure 340 and the battery housing 320 (e.g., a non-structural sealed housing). In some embodiments, the separation of the battery structure from the battery housing enables a few benefits. In some examples, the battery assembly can use cost-effective housing parts. For example, the housing part have no structural requirements.

According to certain embodiments, the mounting device 310 is mechanically coupled to the battery structure 340 disposed in the battery housing 320. In some embodiments, the mounting device 310 is mechanically coupled to the battery structure 340 to reduce the complexity of sealing. In certain embodiments, the battery structure is configured to support battery including, for example, a plurality of battery modules, a plurality of battery cells. In some embodiments, the battery structure 340 is made from a first material (e.g., a metal, aluminum) and the battery housing 320 is made from a second material (e.g., fiber glass, thermal-insulated material), where the first material is different from the second material. In certain embodiments, the first material is a metal material. In some embodiments, the second material is a non-metallic material. In certain embodiments, the second material has a lower cost than the first material. In some embodiments, the second material is a thermal insulated material allowing the enclosed battery (include battery modules and battery cells) to control the battery temperature independent from the environment. In certain embodiments, the first material has a thermal conductivity higher than the thermal conductivity of the second material. In certain embodiments, the battery housing can provide a sealed enclosure for the battery structure and battery (e.g., battery cells, battery packs) inside. In some embodiments, the second material is a conformable material. In certain embodiments, the first material is a non-conformable material (e.g., a rigid material).

According to some embodiments, the battery housing 320 is a non-structural housing. In certain embodiments, the non-structural battery housing 320 is made from conformable material (e.g., flexible material). In In some examples, the battery housing 320 is made from flame retardant materials, for example, providing fire barriers to both internal battery fires (e.g., protects vehicle/people) and/or from external fuel fires (e.g., protecting battery during vehicle-vehicle crash). In certain embodiments, non-structural housing can be made from electrically insulating materials, for example, providing robust high-voltage protection from battery to vehicle/occupants. In some embodiments, non-structural housing can be easy replaced if damaged (e.g., due to road debris, etc.) without replacement of the battery. In certain embodiments, the battery housing is replaceable without replacing battery.

In some examples, for the example battery assembly 300, manufacturability of battery 350 and/or the battery structure 340 is simpler, as the battery structure 340 is not required to protect all faces of the battery 350, and the battery 350 can be sealed in the battery housing 320. In certain examples, the battery housing 320 (e.g., a non-structural housing, a non-structural sealed housing) wraps the battery to accomplish this. In some examples, the non-structural housing decouples the battery structure from external sealed housing. In certain examples, decoupling these parts simplifies design/assembly, lowers costs, improves reliability, eases serviceability, and improves product safety.

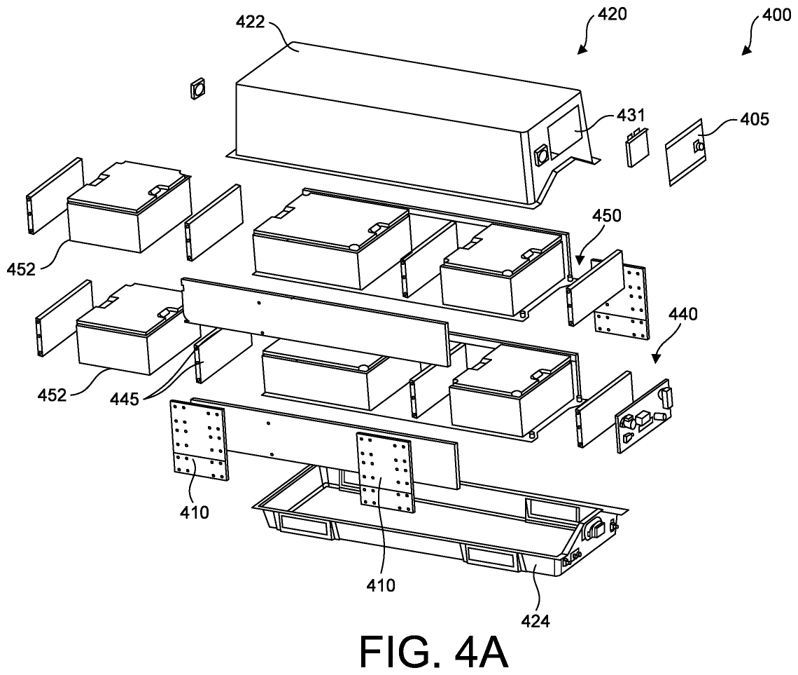

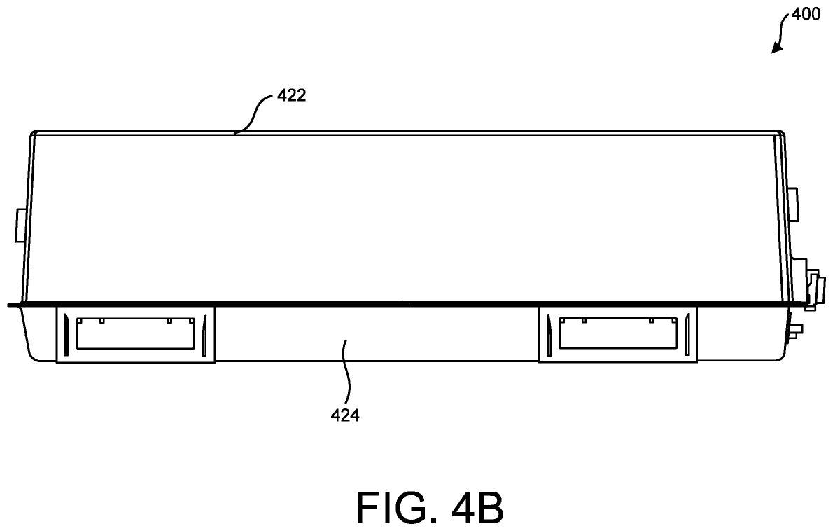

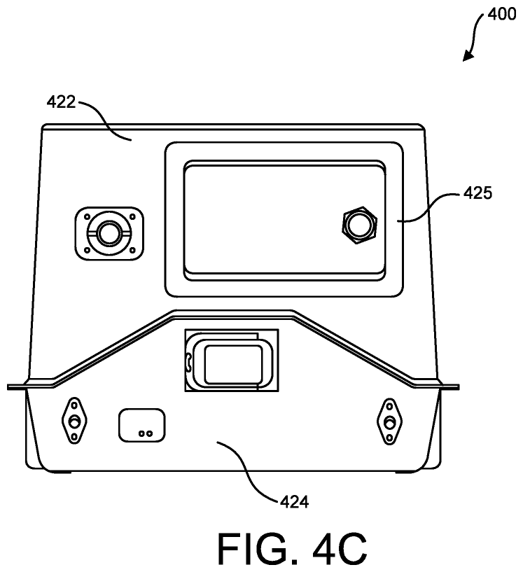

FIG. 4A is an exploded view of a schematic design of an example battery assembly 400; FIG. 4B is a perspective view of the example battery assembly 400 when the battery assembly 400 is assembled; and FIG. 4C is a different perspective view of the example battery assembly 400. FIGS. 4A-4C illustrate merely an example. One of ordinary skill in the art would recognize many variations, alternatives, and modifications. According to certain embodiments, the battery assembly 400 includes a battery housing 420, a battery structure 440, and a battery 450. Although the above has been shown using a selected group of components for the battery assembly 400, there can be many alternatives, modifications, and variations. For example, some of the components may be expanded and/or combined. Other components may be inserted to those noted above. Depending upon the embodiment, the arrangement of components may be interchanged with others replaced.

According to certain embodiments, the battery housing 420 includes a top housing 422 and a bottom housing 424. In some embodiments, the battery housing 420 is in a rectangular shape in a side view and/or an end view. In certain embodiments, the battery structure 440 includes a plurality of supporting components. In some embodiments, the battery 450 includes a plurality of battery cells.

In some embodiments, the battery housing 420 includes one or more ports 431 (e.g., power port, communication port) disposed thereon. In some embodiments, the battery housing 420 includes one or more cooling ports (not illustrated). In certain embodiments, the battery assembly 400 includes a service panel 405.

According to some embodiments, the battery housing 420 contains the battery structure 440 and the battery 450. In certain embodiments, the battery structure 440 includes one or more supporting structures 445. In some embodiments, the battery structure 440 includes a plurality of supporting structures 445. In certain embodiments, the battery 450 includes one or more battery modules 452, also referred to as battery cells. In some embodiments, a battery cell 452 is a battery pack. In certain embodiments, a battery cell 452 is a battery module that further includes a plurality of battery cells. In some embodiments, the battery module (e.g., a battery cell) 452 includes a cooling component, for example, at a bottom side. In certain embodiments, a battery cell 452 is a battery pack without battery module(s). In some embodiments, a battery 450 includes electrical conductors and/or sensors.

According to certain embodiments, the battery assembly 400 has a separate battery structure 440 and the battery housing 420 (e.g., a non-structural sealed housing). In some embodiments, the separation of the battery structure from the battery housing enables a few benefits. In some examples, the battery assembly can use cost-effective housing parts. For example, the battery housing has no structural requirements.

According to certain embodiments, the mounting device 410 is mechanically coupled to the battery structure 440 disposed in the battery housing 420. In some embodiments, the mounting device 410 includes a first portion (e.g., a plate) disposed in the battery housing when the battery assembly 400 is assembled. In certain embodiments, the mounting device 410 includes a second portion disposed outside the battery housing when the battery assembly 400 is assembled. In certain embodiments, the mounting device 410 is mechanically coupled to the battery structure 440 to reduce the complexity of sealing. In some embodiments, the mounting device 410 is mechanically coupled to the battery structure 440 to reduce the complexity of sealing. In certain embodiments, the battery structure is configured to support battery including, for example, a plurality of battery modules 452, a plurality of battery cells 452.

In some embodiments, the battery structure 440 is made from a first material (e.g., a metal, aluminum) and the battery housing 420 is made from a second material (e.g., fiber glass, a flame retardant material, a thermal-insulated material), where the first material is different from the second material. In certain embodiments, the first material is a metal material. In some embodiments, the second material is a non-metallic material. In certain embodiments, the second material has a lower cost than the first material. In some embodiments, the second material is a thermal insulated material allowing the enclosed battery (include battery modules and battery cells) to control the battery temperature independent from the environment. In certain embodiments, the first material has a thermal conductivity higher than the thermal conductivity of the second material. In certain embodiments, the battery housing can provide a sealed enclosure for the battery structure and battery (e.g., battery cells, battery packs) inside. In some embodiments, the second material is a conformable material. In certain embodiments, the first material is a non-conformable material (e.g., a rigid material).

According to some embodiments, the battery housing 420 is a non-structural housing. In certain embodiments, the non-structural battery housing 420 is made from conformable material (e.g., flexible material). In some embodiments, the battery housing 420 has fewer seams than the conventional design to reduce risk of leakage. In some examples, the battery housing 420 is made from flame retardant materials, for example, providing fire barriers to both internal battery fires (e.g., protects vehicle/people) and/or from external fuel fires (e.g., protecting battery during vehicle-vehicle crash). In certain embodiments, non-structural housing can be made from electrically insulating materials, for example, providing robust high-voltage protection from battery to vehicle/occupants. In some embodiments, non-structural housing can be easy replaced if damaged (e.g., due to road debris, etc.) without replacement of the battery. In certain embodiments, the battery housing is replaceable without replacing battery.

In some examples, for the example battery assembly 400, manufacturability of battery 450 and/or the battery structure 440 is simpler, as the battery structure 440 is not required to protect all faces of the battery 450, and the battery 450 can be sealed in the battery housing 420. In certain examples, the battery housing 420 (e.g., a non-structural housing, a non-structural sealed housing) wraps the battery to accomplish this. In some examples, the non-structural housing decouples the battery structure from externally sealed housing. In certain examples, decoupling these parts simplifies design/assembly, lowers costs, improves reliability, eases serviceability, and improves product safety.

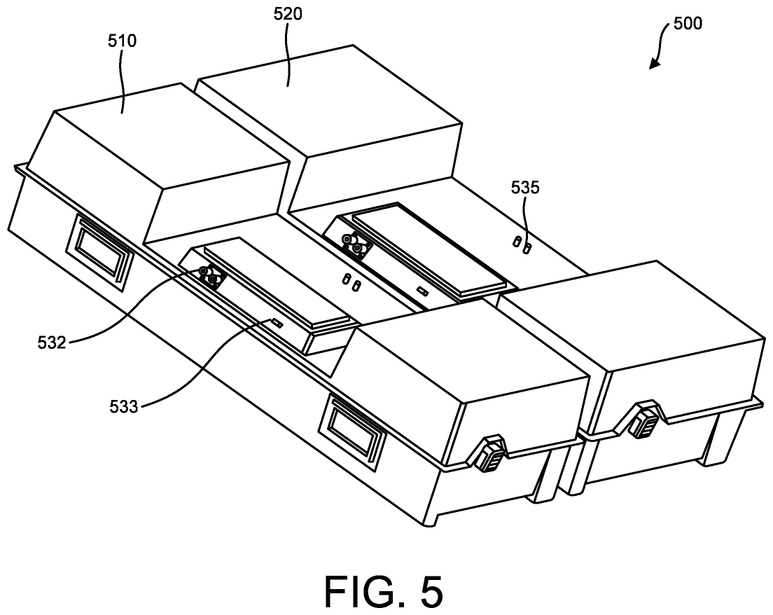

FIG. 5 is a perspective view of a schematic design of an example battery assembly set 500. FIG. 5 is merely an example. One of ordinary skill in the art would recognize many variations, alternatives, and modifications. According to certain embodiments, the battery assembly set 500 includes a first battery assembly 510 and a second battery assembly 520. Although the above has been shown using a selected group of components for the battery assembly set 500, there can be many alternatives, modifications, and variations. For example, some of the components may be expanded and/or combined. Other components may be inserted to those noted above. Depending upon the embodiment, the arrangement of components may be interchanged with others replaced.

According to certain embodiments, the battery assembly set 500 includes one or more battery assemblies using any of the embodiments disclosed herein (e.g., the battery assembly 100 in FIG. 1). In some embodiments, each battery assembly includes a power port 532, a communication port 533, and a cooling port 535. In certain embodiments, each battery assembly can be controlled and/or addressed individually. In some embodiments, the battery assembly set 500 includes one or more mounting devices (e.g., the mounting device 110 in FIG. 1) to assemble to a vehicle chassis rail. In certain embodiments, the battery assembly set 500, including the two battery assemblies 510 and 520 are configured to mechanically couple to a vehicle chassis rail using one or more mounting devices. In some embodiments, each battery assembly in the battery assembly set 500 includes a mounting device, for example, configured to mechanically couple to a vehicle chassis rail.

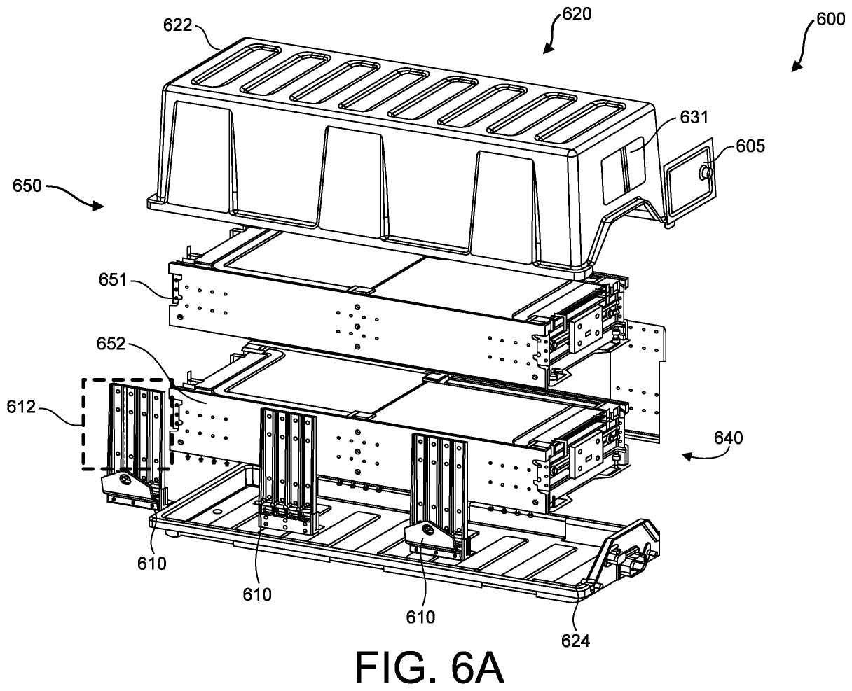

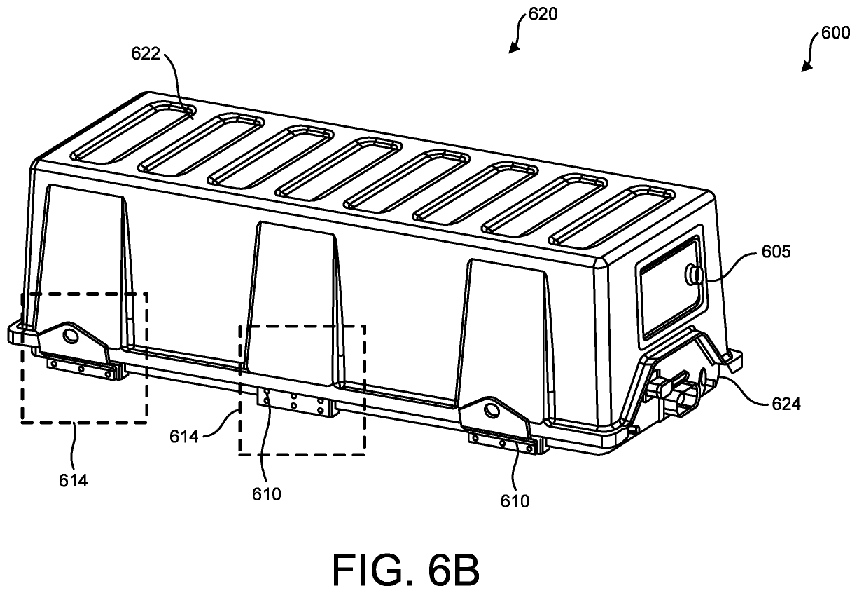

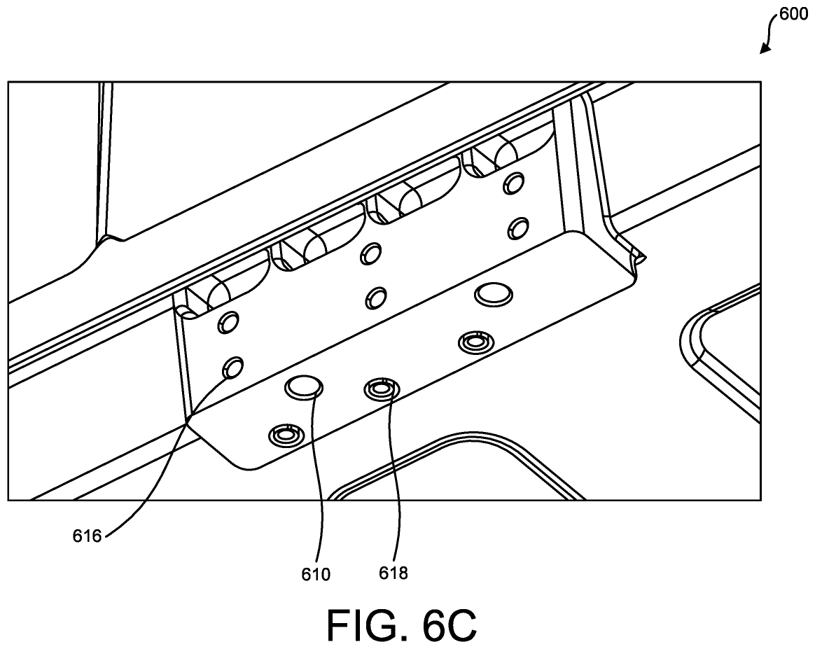

FIG. 6A is an exploded view of a schematic design of an example battery assembly 600; FIG. 6B is a perspective view of the example battery assembly 600 when the battery assembly 600 is assembled; and FIG. 6C is an enlarged view of a portion of the example battery assembly 600. FIGS. 6A-6C illustrate merely an example. One of ordinary skill in the art would recognize many variations, alternatives, and modifications. According to certain embodiments, the battery assembly 600 includes a battery housing 620, a battery structure 640, and a battery 650. Although the above has been shown using a selected group of components for the battery assembly 600, there can be many alternatives, modifications, and variations. For example, some of the components may be expanded and/or combined. Other components may be inserted to those noted above. Depending upon the embodiment, the arrangement of components may be interchanged with others replaced.

According to certain embodiments, the battery housing 620 includes a top housing 622 and a bottom housing 624. In some embodiments, the battery housing 620 is in a rectangular shape in a side view and/or an end view. In certain embodiments, the battery structure 640 includes a plurality of supporting components. In some embodiments, the battery 650 includes a plurality of battery cells.

In some embodiments, the battery housing 620 includes one or more ports 631 (e.g., power port, communication port) disposed thereon. In some embodiments, the battery housing 620 includes one or more cooling ports (not illustrated). In certain embodiments, the battery assembly 600 includes a service panel 605.

According to some embodiments, the battery housing 620 contains the battery structure 640 and the battery 650. In certain embodiments, the battery structure 640 includes one or more supporting structures. In some embodiments, the battery structure 640 includes a plurality of supporting structures. In certain embodiments, the battery 650 includes one or more battery modules 652, also referred to as battery cells. In some embodiments, a battery cell 652 is a battery pack. In certain embodiments, a battery cell 652 is a battery module that further includes a plurality of battery cells. In some embodiments, the battery module (e.g., a battery cell) 652 includes a cooling component, for example, at a bottom side. In certain embodiments, a battery cell 652 is a battery pack without battery module(s). In some embodiments, a battery 650 includes electrical conductors and/or sensors.

According to certain embodiments, the battery assembly 600 has a separate battery structure 640 and the battery housing 620 (e.g., a non-structural sealed housing). In some embodiments, the separation of the battery structure from the battery housing enables a few benefits. In some examples, the battery assembly can use cost-effective housing parts. For example, the battery housing has no structural requirements.

According to certain embodiments, the mounting device 610 is mechanically coupled to the battery structure 640 disposed in the battery housing 620. In some embodiments, the mounting device 610 includes a first portion 612 (e.g., a plate) disposed in the battery housing when the battery assembly 600 is assembled. In certain embodiments, the mounting device 610 includes a second portion 614 disposed outside the battery housing when the battery assembly 600 is assembled. In some embodiments, the mounting device 610 includes one or more side-mount components 616 (e.g., 6 side-mount components) and one or more bottom-mount components 618 (e.g., 3 bottom-mount components). In certain embodiments, the mounting device 610 is mechanically coupled to the battery structure 640 to reduce the complexity of sealing. In some embodiments, the mounting device 610 is mechanically coupled to the battery structure 640 to reduce the complexity of sealing. In certain embodiments, the battery structure is configured to support battery including, for example, a plurality of battery modules 652, a plurality of battery cells 652.

In some embodiments, the battery structure 640 is made from a first material (e.g., a metal, aluminum) and the battery housing 620 is made from a second material (e.g., fiber glass, a flame retardant material, a thermal-insulated material), where the first material is different from the second material. In certain embodiments, the first material is a metal material. In some embodiments, the second material is a non-metallic material. In certain embodiments, the second material has a lower cost than the first material. In some embodiments, the second material is a thermal insulated material allowing the enclosed battery (include battery modules and battery cells) to control the battery temperature independent from the environment. In certain embodiments, the first material has a thermal conductivity higher than the thermal conductivity of the second material. In certain embodiments, the battery housing can provide a sealed enclosure for the battery structure and battery (e.g., battery cells, battery packs) inside. In some embodiments, the second material is a conformable material. In certain embodiments, the first material is a non-conformable material (e.g., a rigid material).

According to some embodiments, the battery housing 620 is a non-structural housing. In certain embodiments, the non-structural battery housing 620 is made from conformable material (e.g., flexible material). In some embodiments, the battery housing 620 has fewer seams than the conventional design to reduce risk of leakage. In some examples, the battery housing 620 is made from flame retardant materials, for example, providing fire barriers to both internal battery fires (e.g., protects vehicle/people) and/or from external fuel fires (e.g., protecting battery during vehicle-vehicle crash). In certain embodiments, non-structural housing can be made from electrically insulating materials, for example, providing robust high-voltage protection from battery to vehicle/occupants. In some embodiments, non-structural housing can be easy replaced if damaged (e.g., due to road debris, etc.) without replacement of the battery. In certain embodiments, the battery housing is replaceable without replacing battery.

In some examples, for the example battery assembly 600, manufacturability of battery 650 and/or the battery structure 640 is simpler, as the battery structure 640 is not required to protect all faces of the battery 650, and the battery 650 can be sealed in the battery housing 620. In certain examples, the battery housing 620 (e.g., a non-structural housing, a non-structural sealed housing) wraps the battery to accomplish this. In some examples, the non-structural housing decouples the battery structure from externally sealed housing. In certain examples, decoupling these parts simplifies design/assembly, lowers costs, improves reliability, eases serviceability, and improves product safety.

Furthermore, no element, component, or method step in the present disclosure is intended to be dedicated to the public regardless of whether the element, component, or method step is explicitly recited in the claims. No claim element herein is to be construed under the provisions of 35 U.S.C. § 112(f), unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art. Accordingly, the foregoing description and drawings are by way of example only.

What is claimed is:

1. A battery assembly, comprising:
a battery housing is made from a first material;
a battery structure disposed in the battery housing and is made from a second material different from the first material; and
a battery comprising a plurality of battery cells disposed on the battery structure; and
wherein the battery housing is sealed.

2. The battery assembly of claim 1, further comprising;
a mounting device mechanically coupled to the battery structure via a connector; and
wherein the battery housing does not mechanically connected to the mounting device via a connecting device.

3. The battery assembly of claim 1, wherein the mounting device includes a portion disposed within the battery housing when the battery assembly is assembled.

4. The battery assembly of claim 1, wherein the battery housing is configured to be removable from the battery structure.

5. The battery assembly of claim 1, wherein the battery housing is sealed.

6. The battery assembly of claim 1, wherein the first material includes a thermal insulated material, a flame retardant material, or an electrical insulated material.

7. The battery assembly of claim 1, wherein the battery housing has a general top surface, a first side structure protruded from the general top surface, a second side structure protruded from the general top surface.

8. The battery assembly of claim 1, wherein the battery includes a plurality of battery cells, wherein the plurality of battery cells are supported by the battery structure.

9. The battery assembly of claim 1, wherein the mounting device is configured to couple to a rail in a vehicle.

10. A battery assembly, comprising:
a battery housing is made from a first material;
a battery structure disposed in the battery housing and is made from a second material different from the first material; and
a battery comprising a plurality of battery cells disposed on the battery structure; and
wherein the battery housing is sealed;
wherein the battery includes a plurality of battery cells, wherein the plurality of battery cells are supported by the battery structure.

11. The battery assembly of claim 10, further comprising;
a mounting device mechanically coupled to the battery structure via a connector; and
wherein the battery housing does not mechanically connected to the mounting device.

12. The battery assembly of claim 10, wherein the mounting device includes a portion disposed within the battery housing when the battery assembly is assembled.

13. The battery assembly of claim 10, wherein the battery housing is configured to be removed from the battery structure.

14. The battery assembly of claim 10, wherein the battery housing is sealed.

15. The battery assembly of claim 10, wherein the first material includes a thermal insulated material, a flame retardant material, or an electrical insulated material.

16. A battery assembly, comprising:
a battery housing having a general top surface and a first side structure protruded from the general top surface;
a battery structure disposed in the battery housing;
a battery disposed in the battery housing and supported by the battery structure; and
a mounting device mechanically coupled to the battery structure.

17. The battery assembly of claim 16, wherein the battery includes a plurality of battery cells, wherein the plurality of battery cells are supported by the battery structure.

18. The battery assembly of claim 16, wherein the battery housing includes a second side structure protruded from the general top surface, wherein the mounting device includes a first mounting component proximate to the first side structure and coupled to the battery structure, wherein the mounting device includes a second mounting component proximate to the first side structure and coupled to the battery structure.

19. The battery assembly of claim 18, wherein the first mounting component includes a connector mechanically coupled to the battery structure.

20. The battery assembly of claim 16, wherein the battery housing is made from a first material, wherein the battery structure is made from a second material different from the first material.
